(19) United States
(12) Patent Application Publication
(10) Pub. No.: US 2011/0320237 A1
(43) Pub. Date: Dec. 29, 2011

(54) Meeting Calendar Optimization

(75) Inventors: Brian S. Beaman, Apex, NC (US); Mark K. Hoffmeyer, Rochester, MN (US); Joseph C. Diepenbrock, Raleigh, NC (US); John L. Colbert, Bryon, MN (US); Roger S. Krabbenhoft, Rochester, MN (US); Sandra J. Shirk/Heath, Rochester, MN (US); William L. Brodsky, Binghamton, NY (US)

(73) Assignee: International Business Machines Corporation, Armonk, NY (US)

(21) Appl. No.: 12/821,755

(22) Filed: Jun. 23, 2010

(51) Int. Cl. G06Q 10/00

(52) U.S. Cl. 705/7.24

(57) ABSTRACT

A method, a computer program product, and an apparatus is provided for scheduling meetings which includes (1) evaluating a set of proposed meetings, (2) creating a number of calendars, each calendar containing schedule date for the proposed meetings, (3) ranking each calendar according to a calendar evaluation criteria and providing the ranking data with the calendar, and (4) displaying several of the calendars and their respective ranking data.

### BACKGROUND OF THE INVENTION

1. Technical Field

The present invention relates to scheduling of meetings. In particular, the present invention relates to the creation of optimized meeting calendars.

2. Description of the Related Art

In today's work environment, it is quite normal for members of an organization to have a significant number of meetings every day of every week throughout the year. While individuals and organizations have access to computer workstations which provide automated calendaring and scheduling of meetings, efficiently scheduling meetings to provide organizational efficiency has become an increasingly greater challenge.

### SUMMARY

In accordance with the present invention, a method for scheduling meetings is provided that includes the steps of (1) evaluating a set of proposed meetings, (2) creating a set of calendars, each calendar containing potential schedule dates for the proposed meetings, (3) ranking each calendar according to a calendar evaluation criteria and providing the ranking data with the calendar, and (4) displaying several of the calendars and their respective ranking data.

### BRIEF DESCRIPTION OF THE DRAWINGS

The present invention may be better understood, and its numerous objects, features, and advantages made apparent to those skilled in the art by referencing the accompanying drawings.

FIG. 1 is block diagram of a typical computer workstation;

FIG. 2 is high level flowchart of the meeting calendar optimization software program;

FIG. 3 is a flowchart of the input calendar block of FIG. 2;

FIG. 4 is a flowchart of the calendar and meeting evaluation block of FIG. 2;

FIG. 5 is a flowchart of the meeting optimization analysis block of FIG. 2;

FIG. 6 is a flowchart of the first calendar set creation block of FIG. 5;

FIG. 7 is a first portion of the flowchart of the meeting scheduling tasks of block 152 of FIG. 6;

FIG. 8 is a second portion of the flowchart of the meeting scheduling tasks of block 152 of FIG. 6;

FIG. 9 is a flowchart of the second calendar set creation block of FIG. 5;

FIG. 10 is a first portion of the flowchart of the meeting scheduling tasks of block 234 of FIG. 9;

FIG. 11 is a second portion of the flowchart of the meeting scheduling tasks of block 234 of FIG. 9;

FIG. 12 is a flowchart of the evaluation calendar block of FIG. 5;

FIG. 13 is typical calendar form used for scheduling meetings;

FIG. 14 is a meeting list with example meetings; and

FIG. 15 is an illustration of a user display of evaluated calendars provided by the meeting calendar optimization software program.

### DETAILED DESCRIPTION

The following is intended to provide a detailed description of an example of the invention and should not be taken to be limiting of the invention itself. Rather, any number of variations may fall within the scope of the invention, which is defined in the claims following the description.

The present invention is a method for scheduling meetings that includes evaluating a set of proposed meetings and creating meeting calendars where each calendar contains proposed schedule dates for each of the meetings. These calendars are ranked against each other according to calendar evaluation criteria. At least several of the calendars are then display including the calendar ranking information. The user then has several different calendars to choose from in deciding which meeting schedule calendar provides the greatest organization efficiency or which calendar best meets other organizational needs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction implementation system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction implementation system, apparatus, or device.

Program code embodied on a computer readable medium may be transmitted using any appropriate medium, including but not limited to wireless, wire line, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may be implemented entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which are implemented via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which are implemented on the computer or other programmable apparatus provide processes for implementing the functions/acts specified in the flowchart and/or block diagram block or blocks.

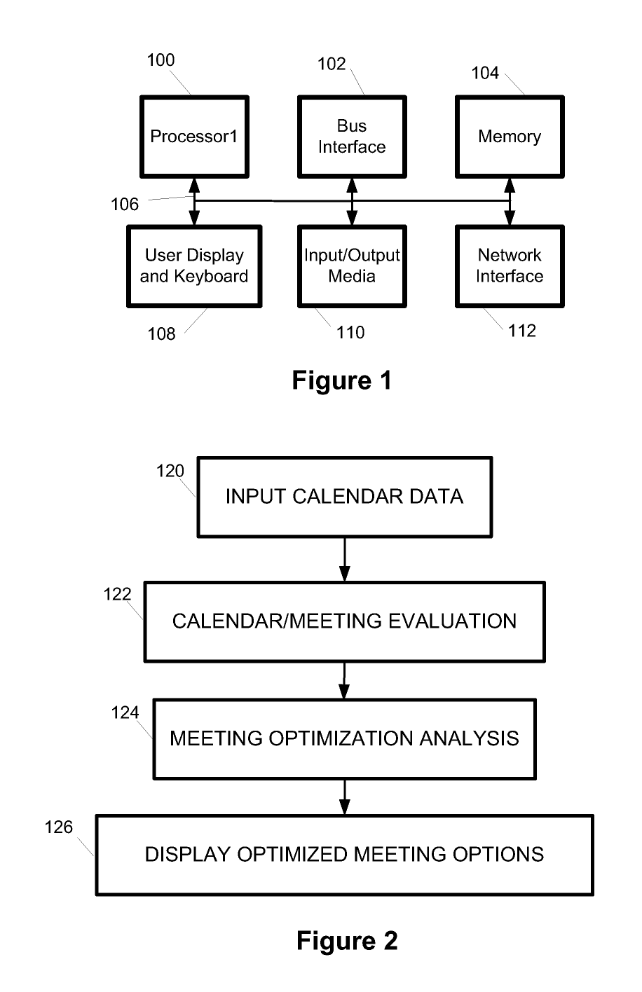

FIG. 1 is a block diagram of a typical computer workstation that would be used by a member of a business organization. Processor 100 is connected to a data bus 106 to communicate with a user display and keyboard. The workstation further includes a bus interface 102 that provides an interface to external peripherals. In addition, a memory 104 is connected to the data bus 106. This memory 104 may contain programs and data for implementation in the processor 100. An input/output interface 110 for media is also connected to the data bus 106 and provides computer media capabilities such as reading and writing of compact disks or other storage media. Lastly, a network interface 112 is provided to connect to an organizational network such as a local area network.

FIG. 2 is a top-level flowchart of a preferred embodiment of the meeting calendar optimization invention. In this flowchart the first task 120 provides the input of calendar data. Calendar data includes meeting information such as a proposed preferred meeting day/time, available meeting days/times, attendees, meeting duration and meeting subjects. Task 122 provides the initial evaluation of the meetings. In task 124, the meetings are scheduled according to an optimization algorithm. In a preferred embodiment, this algorithm would include an input varied to produce several calendars for the proposed meetings. As an example, for a single organization in a single month, several different calendars would be provided that would schedule meetings according to the optimization algorithm. These calendars are then ranked or graded using a calendar evaluation criteria specified by the user. In one preferred embodiment, the evaluation criterion is the number of free hours available on the calendar after all the meetings have been scheduled. Lastly, in task 126, a number of these optimized calendars are displayed to the user along with the ranking data. This allows the user, usually an administrator for the organization, to consider different calendars to be considered in view of other organizational factors.

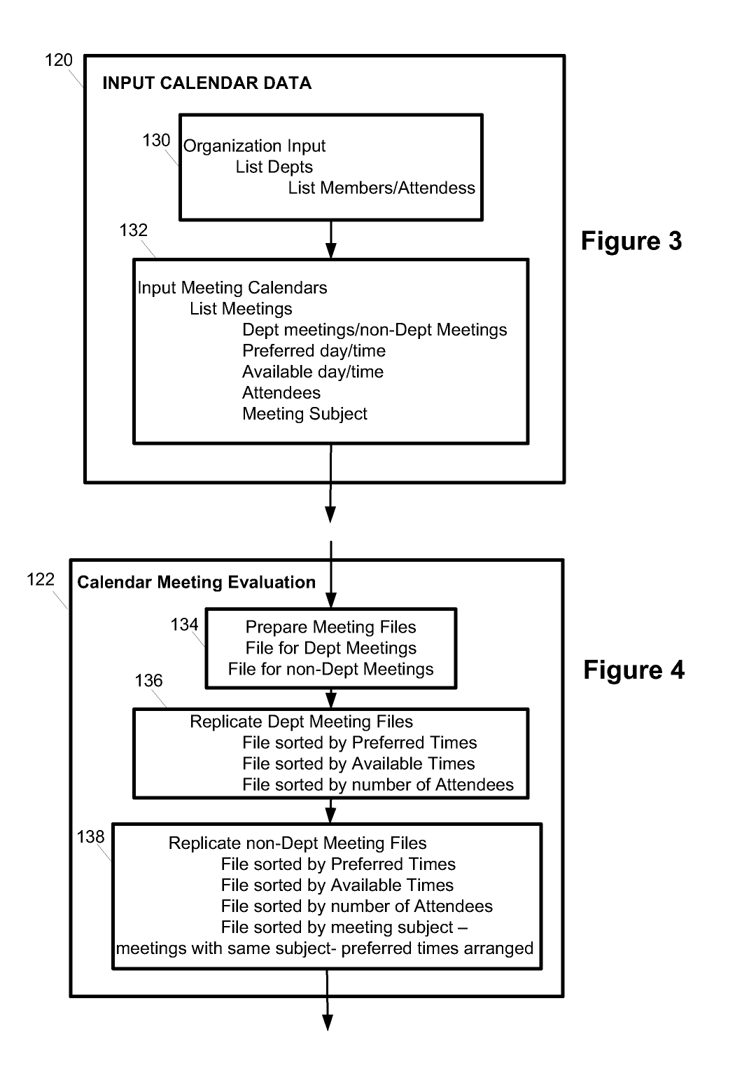

FIG. 3 is a software block diagram of the input calendar data task 120 from FIG. 2. In FIG. 3, block 130, the organization structure is input. In a preferred embodiment, this would include a list of the departments and the members of these departments. In block 132, the meetings for the organization are input. For this embodiment, the meeting information includes whether the meeting is a department meeting or a non-department meeting. Department meetings are in the organization and include members of the department. Department meetings, for this embodiment, are scheduled by department management. Non-department meetings include members of the organization but can also include members outside of the organization. For this embodiment, non-department meetings have a lower priority than department meetings. In addition, the meeting preferred time and day for a meeting is provided along with the available time and day for meetings. Also, the meeting attendees are provided along with the subject of the meeting. In the preferred embodiment the subject is only provided for non-department means.

In FIG. 4 task 122, the calendar meeting valuation task, is illustrated. In block 134, the meeting files are prepared. In the illustrated embodiment, there are separate files for department meetings and non-department meetings. For this embodiment, the preparation of meeting files will result in several copies of each file where each copy will be provided for individual calendar optimizations. In other words, if 20 calendars are to be provided through the optimization algorithm, there would be at least 20 different files for both department meetings and non-department meetings. In block 136, the department meeting files are then replicated and stored and sorted according to preferred times and days, available times and days, and sorted by the number of attendees for the meeting. In block 138, the non-department meeting files are replicated. These files are sorted by preferred times and days, by available times and days, by the number for attendees, and by the subjects of the meeting. One feature of the preferred embodiment is to alter the preferred times of meetings having the same subjects. In other words, two meetings having the same subject will have their preferred meeting times altered to include the preferred of the other meeting within the bounds of their respective available meeting times. This would ensure that the meetings would be scheduled together in the calendar scheduling process.

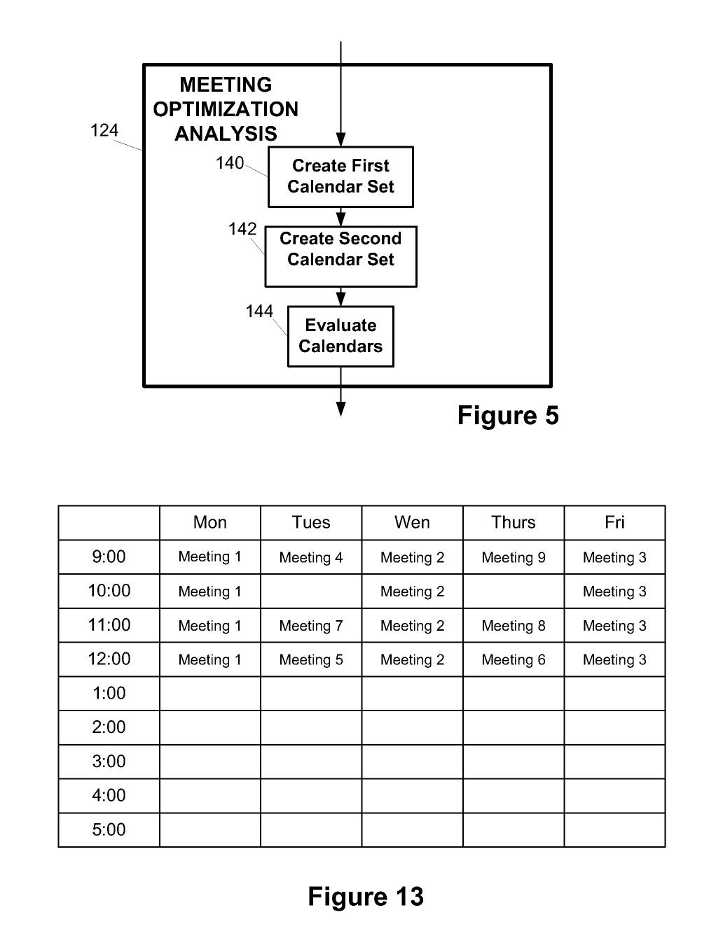

In FIG. 5, the meeting optimization analysis task 124 is shown. For this embodiment, this task 124 includes block 140 showing the creation of a first set of calendars followed by block 142 which is a creation of a second set of calendars. In other embodiments, additional sets of calendars may be created using different algorithms. In block 144, the calendar sets are evaluated and ranked or graded such that each one of the calendars can be compared to the other calendars and displayed in a manner to the user that will allow the user to select one or more calendars for consideration.

Block 140, the creation of the first calendars set, is illustrated in FIG. 6. In block 150, the day and time is initialized to begin the meeting scheduling algorithm as for example, the first meeting time of the first day of the week. In block 151, any meetings having a fixed schedule that are identical to the set fixed day/time are scheduled by the process and the attendees to these meetings are set as unavailable. In other words, these fixed schedule meetings are scheduled in this invention before the meeting scheduling optimization process begins. Since this invention is directed to meetings with a flexible schedule, the following simplified example provided does not include any meetings with a fixed day and time. In the simplified example provided for this embodiment, only 4 hours per day for 5 days per week are being provided. It should be understood that this can be altered by user. Also, in this simplified example, only one week is considered. Obviously, this would be altered by the user to fit the organizational planning requirements. In block 152, the department meeting file and non-department meeting file are scanned for schedulable meetings and these meetings are scheduled. In block 154 and block 156, each meeting file is scanned to determine which meeting is available for scheduling and, in block 158, the meeting is scheduled. This meeting scheduling task is discussed in greater detail in other Figures. After the scheduling, the time of day is incremented and in block 160. The end of day is determined in block 162. If it is not the end of day, the time is incremented in block 164 and the program returns to the scheduling task of block 152. If the end of day has occurred, the day is incremented in block 166 and it is determined whether the end of the week has occurred in block 168. If not, in block 170 the time is reset to the first schedule meeting time and the process of block 152 is repeated. If the end of the week has been reached, the calendar is stored in block 172 and in block 174, the program determines if another calendar is to be configured. If not, the time/day are reset in block 176 and the program returns to block 152. If the last calendar has been reached has been configured, the program then exits.

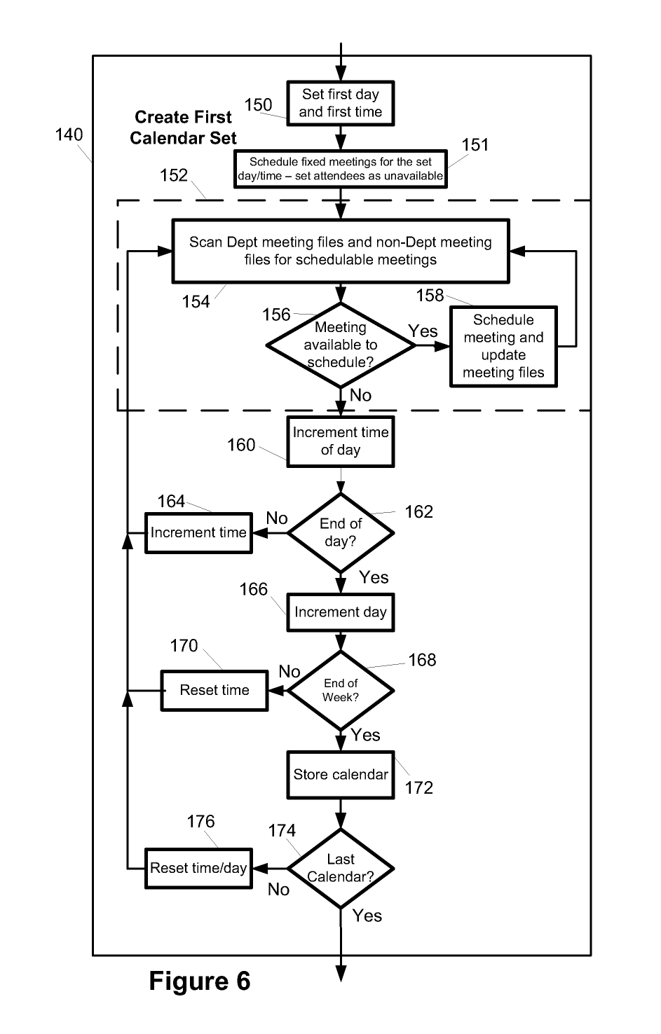

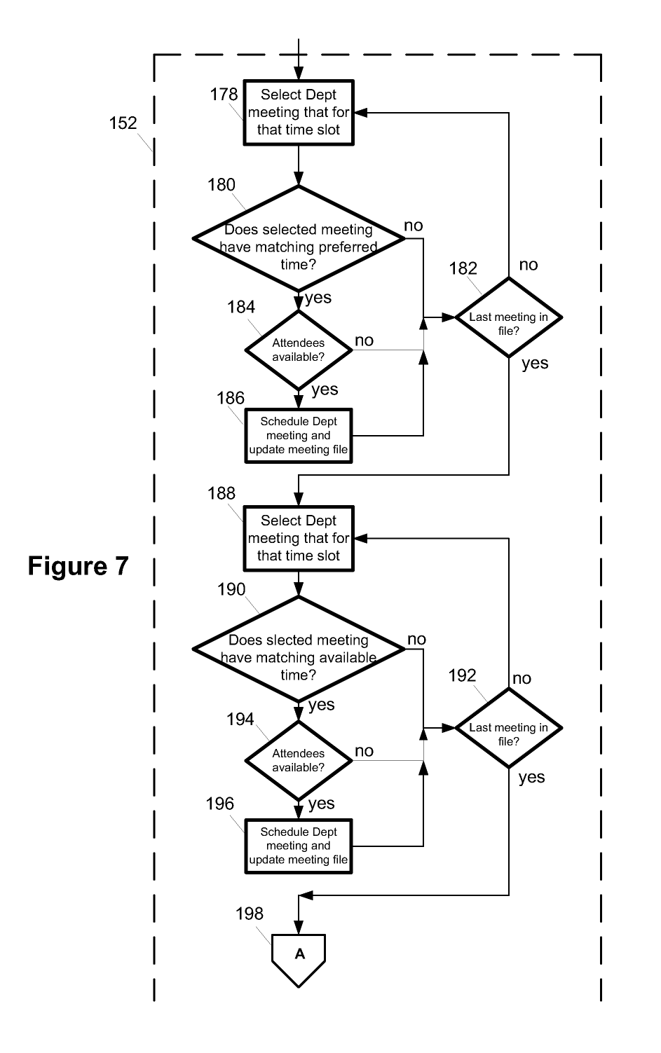

In FIG. 7, the meeting scheduling task of block 152 is disclosed in greater detail. In block 178, a department meeting is selected for the time slot. In other words, the first department meeting in the department meeting file is examined. In block 180, it is determine whether that meeting has a matching preferred time to the time slot. If so, in block 184, it is determine whether the attendees are available. If so, in block 186, the meeting is scheduled and the meeting file is updated accordingly. At this point, the program returns to block 182 to determine if that is the last meeting in the file to be reviewed. Likewise, if the scheduled meeting does not match the preferred time or the attendees are not available, the meeting is not scheduled and the program returns to block 182. If the meeting is not the last meeting in the file, the program returns to block 178 to review the next department meeting in the file. However, if the meeting is the last meeting in the file than the program precedes the block 188 to again select a department meeting for that time slot. It should be understood that the operation of block 178 is identical to the operation of block 188. In block 188, the selected department meeting is then reviewed to determine if the department meeting is available according to the current time slot. This is different from block 180 which just determines whether it the time slot matched a preferred time slot for the meeting. Returning to block 190, if the meeting is available to be scheduled, in block 194 it is determine whether the attendees are available. If so, then the meeting is scheduled in block 196 and the file is updated accordingly. Like block 182, block 192 determines whether this meeting is the last meeting in the file and, if not, a new department meeting is selected for review. Likewise, if the selected meeting does not match the available time or the attendees are not available, the program returns back to block 192 to examine the next meeting in the file to determine if more meetings are in the file.

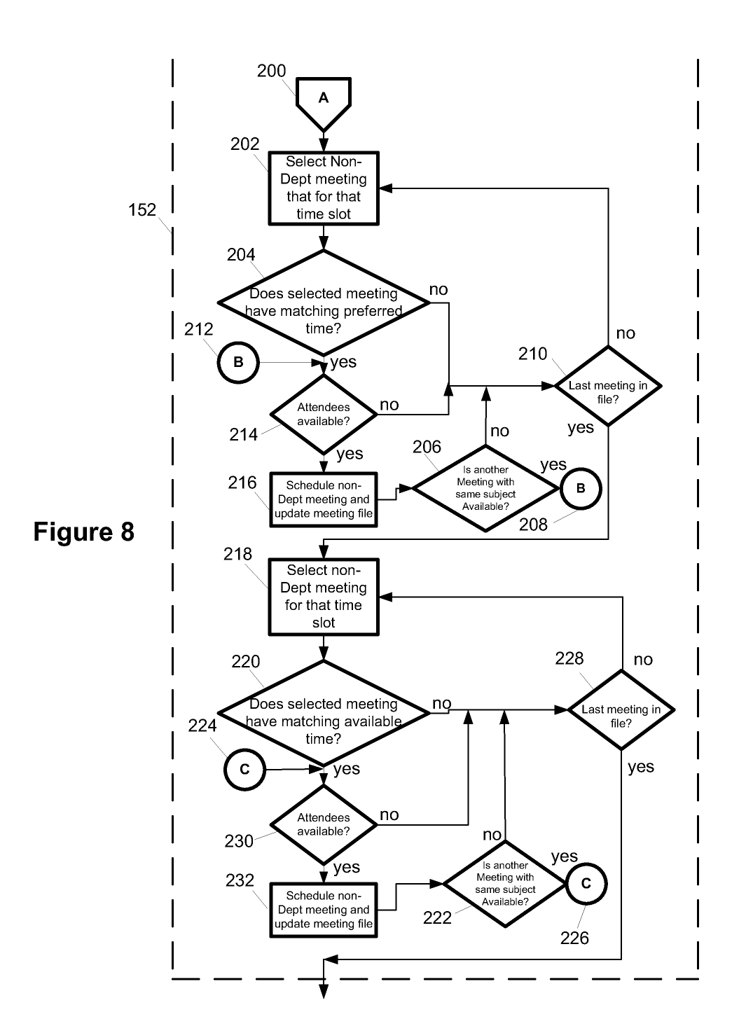

If the last meeting in that file has been reviewed, the program proceeds through connector 198 to connector 200 in FIG. 8 and to then select the non-department meetings in block 202 for that time slot. In block 204, it is determined whether the selected non-department meeting has a matching preferred time. If so, block 214 determines whether the attendees are available. If so, in block 216, the non-department meeting is scheduled. Block 206 determines if any other non-department meetings in the file have the same subject and, if so, through connectors 208 and 212 determines in block 214 if the attendees are available. When the attendees are available for this additional meeting, the meeting is scheduled in block 216 as before. If another same subject meeting is not in the file or if the attendees are not available, the program proceeds to block 210 to determine whether this is the last meeting in the file. If not, the program returns to block 202. If the last file has been reached in block 210, then in block 218, the non-department meeting file is again examined for that time slot to determine, in block 220, whether there are meetings that are available for that time slot. The process for blocks 220, 230, 232, 222 and 228 is the same as the process described for blocks 204, 214, 216, 206, and 210.

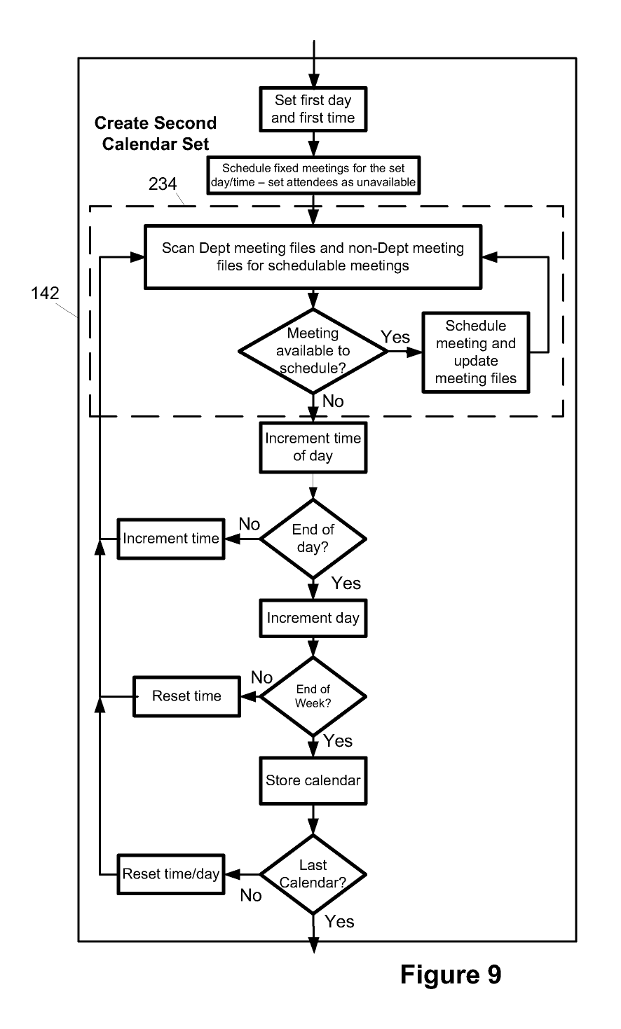

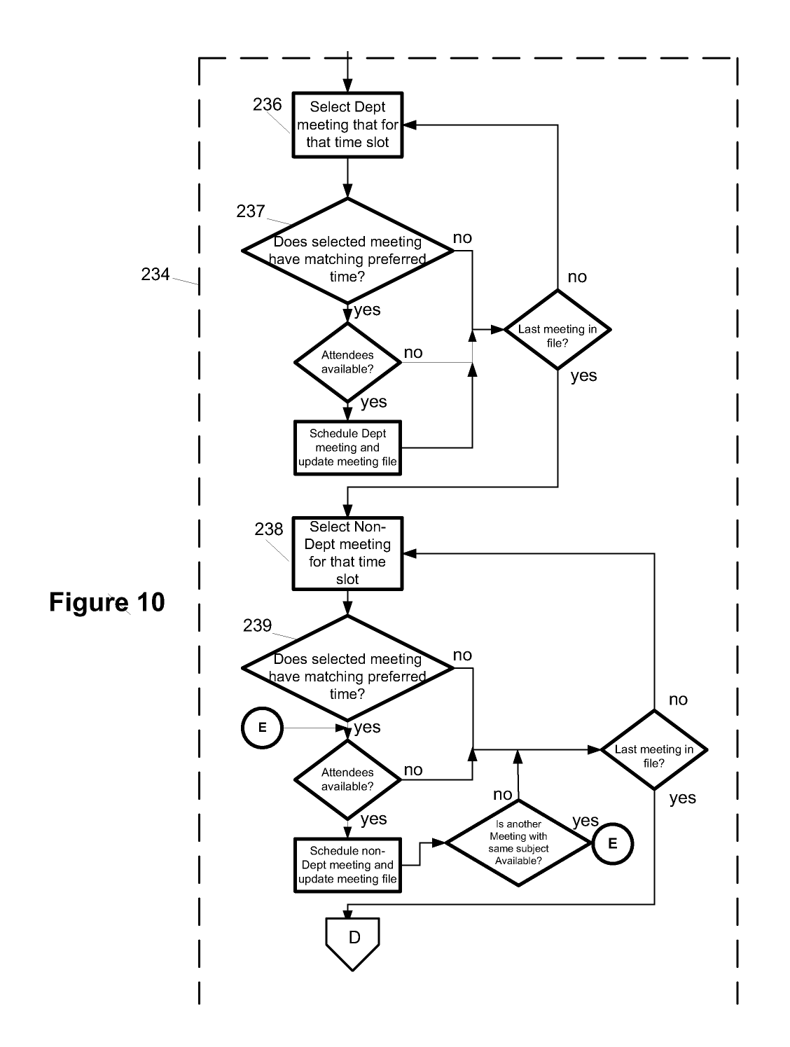

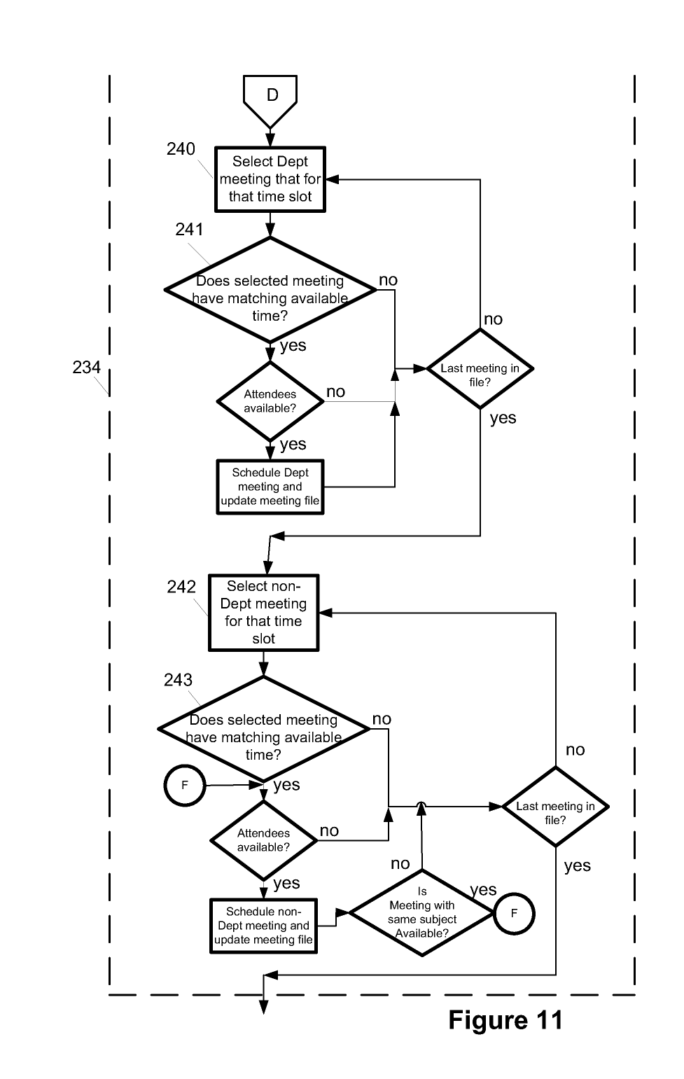

FIG. 9 illustrates block 142 which is the creation of the second calendar set. The process is virtually the same as block 140 in FIG. 6 except for the internal operation of block 234 which is discussed in FIGS. 10 and 11.

In block 234 of FIG. 10, the difference in the meeting scheduling is that in second calendar set, the preferred times selection for department meetings is then followed by the preferred time selection for the non-department meetings. In other words, the sequence of selection for the first calendar set, examining the department meeting preferred times followed by the department meeting available times followed by the non-department meeting preferred time following by the non-department meeting available times is changed. For the second calendar set, the department meetings are selected in block 236 followed by block 237 determining if this meeting has a matching preferred time, same as in the first calendar set. But in block 238, a non-department meeting is selected and in block 239, it is determined if this non-department meeting has a matching preferred time. Likewise, in FIG. 11, block 240 selects a department meeting for available time comparison in block 241 and block 242 selects a non-department meeting for a matching availability time in block 243. In other words, the preferred time/available time examination sequence has been changed to produce a second calendar set.

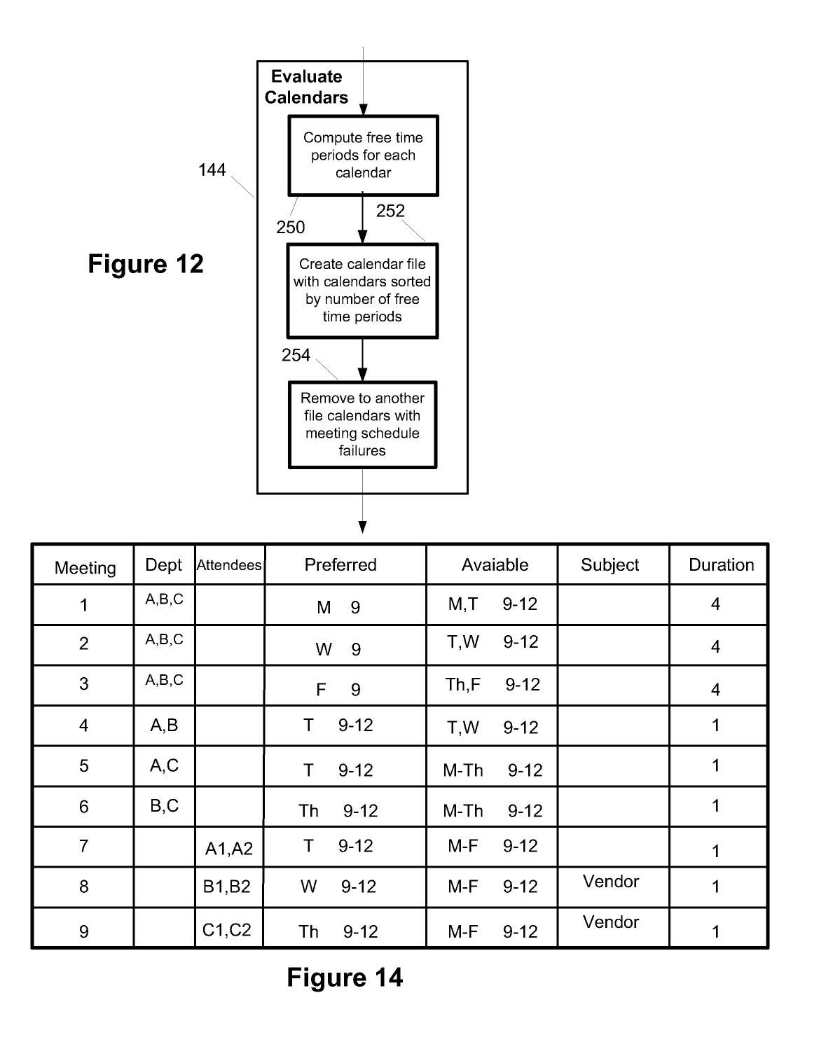

In FIG. 12 the evaluate calendars task 144 is shown including block 250 which computes the free time periods for each of the calendars. In this embodiment, the number of free time slots is the calendar evaluation criteria. In block 252, the calendar files are then sorted according to the number of free time periods. In block 254, another file is created for calendars having meetings that were not able to be scheduled. In other words, if there is a meeting scheduled failure, that calendar is put into a separate file in block 254.

FIG. 13 is an example calendar grid showing a single week of calendar times available from 9 a.m. to 5 p.m and listing the schedules for Meetings 1 through 9. However, as previously stated for this example only 4 hours per day are made available for meeting scheduling. The details of Meetings 1 through 9 are listed in FIG. 14. In this example, the organization consists of three departments: Department A, Department B and Departments C. In FIG. 14, Meetings 1 through 6 are department Meetings. Meetings through 3 include a department meeting for all three Departments A, B, and C. In Meeting 5, the department meetings include Departments A and C while in Meeting 6 Departments B and C are meeting. For department meetings, the column labeled attendees does not include any entries since all members of those departments will be present or will be expected to be present. In the Preferred column of FIG. 14, the preferred dates and times of the meetings are specified. Likewise, in the Available column, the available times and dates of the meetings are specified. In the Subject column, again no subject is listed for department meetings. In the last column, Duration, the duration of the meetings is specified. For Meeting 7, 8 and 9, non-department meetings have been provided in this example. For instance, Meeting 7 includes two members of Department A; A1 and A2. The preferred and available times are listed along with the duration and there is no subject listed for this meeting. For Meetings 8 and 9, the subject ‘Vendor’ is listed. In Meeting 8, the attendees are B1 and B2 and in Meeting 9 the attendees are C1 and C2. Again, this is a overly simplified example merely providing a simple scheduling exercise to show the operation of this invention.

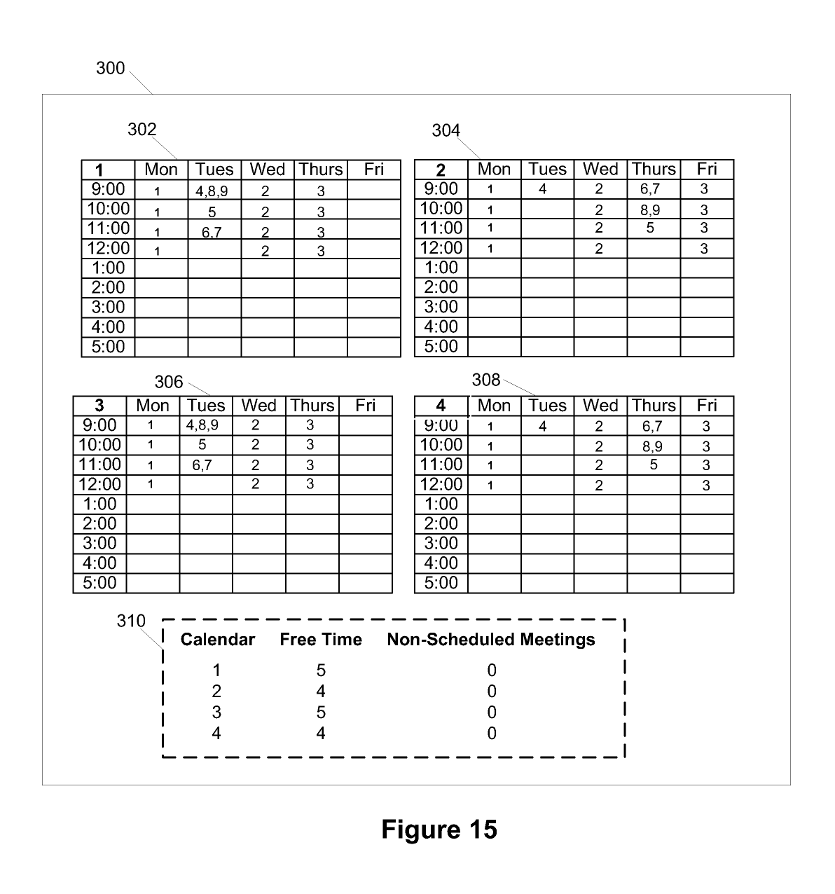

FIG. 15 illustrates an example of the display of the optimization of the meetings in FIG. 14. In FIG. 15, 4 calendars are displayed. In each of the 4 calendars, a schedule of meetings is shown. Calendar 1, reference 302, illustrates the scheduling of the meetings by meeting number for the time slots. In calendar 2, reference 304, a different calendar for the same sets of meetings is illustrated. Likewise, calendar 3, reference 306, and calendar 4, reference 308, represent the second set of calendars with their scheduled meetings shown. Calendars 1 and 2 result from the first calendar set optimization exercise and calendars 3 and 4 result from the second calendar set optimization exercise. It is interesting to note that calendar 1 matches calendar 3 and calendar 2 matches calendar 4 even though the algorithms for each of these calendars are different. Block 310 lists the calendar evaluation results. Therefore, a user, a meeting administrator for the organization, could see the results of several different algorithms used to schedule meetings and could determine which of these displayed calendars might be chosen.

This display is different other prior art that provide a single optimized output. The reason for the multiple calendar display is that many times other factors are present that must be considered for the selection of meeting schedules and these factors cannot be easily provided to a optimization algorithm. It should be also noted that for this example, free time was the calendar evaluation criteria used. Other calendar evaluation criteria may include the number of meetings that were rescheduled from an original calendar such as FIG. 13. The number of meetings that were scheduled at their preferred meeting times could be another calendar evaluation criteria. Also, the number of attendees available to attend may be another criteria.

The display of several calendars with different meeting schedules along with the calendar evaluation criteria for each calendar displayed allows an organization administrator or manager to consider different calendar schedules.

While this example is limited to a single week, another advantage of this invention is the ability to address more irregular recurring scheduled meetings such as meetings occurring ever other week or once a month. The invention would schedule these meetings along with the other meetings in a manner to either overlap these irregular meeting with other scheduled meetings to maximize meetings during a scheduled meeting time period or, alternatively, to schedule irregular meetings at a recurring time period each week so that the schedule would have the advantage of a regular occurring meeting even though these individual meetings have a more irregular schedule (not weekly). As an example, consider a department meeting scheduled every other week and a non-department meeting also scheduled every other week and including many of the same attendees as the department meeting. The invention would attempt to schedule these meeting at the same time each week so that one week the department meeting would occur and the next week the non-department meeting would occur. In this manner, the attendees would have a meeting at the same time each week but the meetings would be the irregular recurring meetings.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method for scheduling meetings comprising the steps of:
evaluating a first plurality of proposed meetings;
creating a first plurality of calendars, each containing schedule data for the plurality of proposed meetings;
ranking each calendar according to a calendar evaluation criteria and providing ranking data; and
displaying a second plurality of the calendars with their respective ranking data.

2. A method according to claim 1 wherein the calendar evaluation criteria includes free time available in the calendar.

3. A method according to claim 1 wherein the creating step includes a step of scheduling meeting of one or more organizational units before the scheduling of a non-organizational meeting.

4. A method according to claim 1 wherein the creating step includes a step of scheduling meetings with identical subject matter at a same time.

5. A method according to claim 1 wherein the creating step includes a step of scheduling meetings having unique attendees at a same time.

6. A computer program product stored in a computer readable media, the computer readable media containing instructions for implementation by a computer, which, when implemented by the computer, causes the computer to implement a method for scheduling meetings, the method comprising the steps of:
(a) evaluating a first plurality of proposed meetings;
(b) creating a first plurality of calendars, each containing schedule data for the plurality of proposed meetings;
(c) ranking each calendar according to a calendar evaluation criteria and providing ranking data; and
(d) displaying a second plurality of the calendars with their respective ranking data.

7. A computer product according to claim 6 wherein the calendar evaluation criteria includes free time available in the calendar.

8. A computer product according to claim 6 wherein the creating step includes a step of scheduling meeting of one or more organizational units before scheduling of non-organizational meetings.

9. A computer product according to claim 6 wherein the creating step includes a step of scheduling meetings with identical subject matter at a same time.

10. A computer product according to claim 6 wherein the creating step includes a step of scheduling meetings having unique attendees at a same time.

11. A system for scheduling meetings comprising:
a processor;
a memory connected to the processor and including program code for (a) evaluating a first plurality of proposed meetings; (b) creating a first plurality of calendars, each containing schedule data for the plurality of proposed meetings; (c) ranking each calendar according to a calendar evaluation criteria and providing ranking data; and (d) displaying a second plurality of the calendars with their respective ranking data; and
a user display device.

12. A system according to claim 11 wherein the program code calendar evaluation criteria includes free time available in the calendar.

13. A system according to claim 11 wherein the program code creating step includes a step of scheduling meeting of one or more organizational units before scheduling of non-organizational meetings.

14. A system according to claim 11 wherein the program code creating step includes a step of scheduling meetings with identical subject matter at a same time.

15. A system according to claim 11 wherein the program code creating step includes a step of scheduling meetings having unique attendees at a same time.
